(19) United States
(12) Patent Application Publication
(10) Pub. No.: US 2021/0048413 A1
(43) Pub. Date: Feb. 18, 2021

(54) FAST PATTERN RECOGNITION USING ULTRASOUND

(71) Applicant: GE Sensing & Inspection Technologies, GmbH, Hurth (DE)

(72) Inventors: Prashanth Kumar Chinta, Hürth (DE); Thomas Wuerschig, Cologne (DE)

(21) Appl. No.: 16/990,578

(22) Filed: Aug. 11, 2020

Related U.S. Application Data
(60) Provisional application No. 62/885,813, filed on Aug. 12, 2019.

(51) Int. Cl. G01N 29/06; G01N 29/07; G01N 29/26; G01N 29/44

(52) U.S. Cl. CPC G01N 29/069; G01N 29/4454; G01N 29/262; G01N 29/07

(57) ABSTRACT

Systems and methods for ultrasonic testing are provided. An ultrasonic probe including a phased transducer array can transmit a plurality of ultrasonic beams (e.g., plane waves) oriented at different directions simultaneously into a target. The plurality of ultrasonic transducers transmitting the ultrasonic waves can also receive ultrasonic echoes resulting from reflection of the plurality of plane waves from the target. Each ultrasonic transducer can measure a single A-scan characterizing the ultrasonic echoes received at that ultrasonic transducer. Based upon A-scans received from the plurality of transducers, a controller can generate an image representing the target and output the image for display by a display device substantially concurrently with transmission of the ultrasonic waves, allowing for real-time display.

### CROSS-REFERENCE TO RELATED APPLICATIONS

This application claims the benefit of U.S. Provisional Patent Application No. 62/885,813, filed Aug. 12, 2019, entitled “Fast Pattern Recognition Using Ultrasound,” the entirety of which is incorporated by reference.

### BACKGROUND

Non-destructive testing (NDT) is a class of analytical techniques that can be used to inspect characteristics of a target, without causing damage, to ensure that the inspected characteristics of the target satisfy required specifications. NDT can be useful in industries that employ structures that are not easily removed from their surroundings (e.g., pipes or welds) or where failures would be catastrophic. For this reason, NDT can be used in a number of industries such as aerospace, power generation, oil and gas transport or refining. Ultrasonic testing is one type of NDT. Ultrasound is acoustic (sound) energy in the form of waves that have an intensity (strength) which varies in time at a frequency above the human hearing range. In ultrasonic testing, one or more ultrasonic waves can be directed towards a target in an initial pulse. As an ultrasonic wave travels through the target, it can reflect from features such as outer surfaces and interior defects (e.g., cracks, porosity, inhomogeneities, etc.), referred to as an ultrasonic echo. An ultrasonic sensor can acquire measurements characterizing ultrasonic echoes resulting from that initial pulse (e.g., amplitude of the echo and time of flight of measured echoes), and the acquired echo measurements can be analyzed to determine target and defect characteristics.

Techniques have been developed to provide multi-dimensional images of defects within the target in real-time from ultrasonic testing data. Real time imaging can be desirable to allow inspectors to see imaged defects while ultrasonic testing is performed. However, existing imaging techniques can acquire a large amount of ultrasonic data and, in order to process this volume of ultrasonic data rapidly enough to produce images in real time, sophisticated and costly electronics can be required. Thus, existing ultrasonic testing systems capable of multi-dimensional defect imaging can be relatively expensive.

### SUMMARY

In general, systems and methods are provided for improved ultrasonic data acquisition for ultrasonic imaging. As discussed in detail below, ultrasonic data acquisition systems and methods are provided which reduce collection of unnecessary and/or redundant ultrasonic data. By reducing the amount of ultrasonic data that is acquired for analysis, ultrasonic images can be generated in real-time by cheaper microprocessors, without the need for expensive electronics, such as field programmable gate arrays (FPGAs).

In an embodiment, a method of ultrasonic testing is provided. The method can include positioning an ultrasonic probe adjacent to a target, the ultrasonic probe including a plurality of ultrasonic transducers arranged in a predetermined array. The method can also include transmitting, by the plurality of ultrasonic transducers, respective ultrasonic waves to form a plurality of plane waves. The plurality of plane waves can be oriented at different predetermined directions with respect to a reference axis and the plurality of plane waves are transmitted substantially simultaneously into the target. The method can further include receiving, by the plurality ultrasonic transducers, ultrasonic echoes resulting from reflection of the plurality of plane waves from the target. The method can additionally include measuring, by each ultrasonic transducer of the plurality of ultrasonic transducers, a single A-scan characterizing the ultrasonic echoes received at that ultrasonic transducer. The method can further include generating, by a controller based upon the measured A-scans, an image representing the target. The method can also include outputting, by the controller, data representing the generated image to a display device.

In another embodiment of the method, the plurality of ultrasonic transducers can be a phased array.

In another embodiment of the method, the plurality of plane waves are not transmitted sequentially.

In another embodiment of the method, an amount of data contained within the single A-scan is less than an amount of data contained within a plurality of A-scans acquired by full matrix capture (FMC).

In another embodiment of the method, an amount of data contained within the single A-scan is less than an amount of data contained within a plurality of A-scans acquired by plane wave imaging (PWI).

In another embodiment of the method, a rate of data generated during measurement of the single A-scan is less than a rate of data generated during measurement of a plurality of A-scans acquired by full matrix capture (FMC).

In another embodiment of the method, a rate of data generated during measurement of the single A-scan is less than a rate of data generated during measurement of a plurality of A-scans acquired by plane wave imaging (PWI).

In an embodiment, an ultrasonic testing system is provided and can include an ultrasonic probe and a controller. The ultrasonic probe can include a plurality of ultrasonic transducers arranged in a predetermined array. The plurality of ultrasonic transducers can also be configured to transmit respective ultrasonic waves in response to receipt of control signals to form a plurality of plane wave. The plurality of plane waves are oriented at different predetermined directions with respect to a reference axis and the plurality of plane waves are transmitted substantially simultaneously into the target. The plurality of ultrasonic transducers can be further configured to receive ultrasonic echoes resulting from reflection of the plurality of plane waves from the target. The plurality of ultrasonic transducers can additionally be configured to measure a single A-scan characterizing the ultrasonic echoes received at respective ones of the plurality of ultrasonic transducers. The controller can include one or more processors and it can be configured to transmit the control signals to the plurality of ultrasonic transducers. The controller can be further configured to generate, based upon the measured A-scans, an image representing the target. The controller can be additionally configured to output data representing the generated image to a display device.

In another embodiment of the system, the plurality of ultrasonic transducers can be a phased array.

In another embodiment of the system, the plurality of plane waves are not transmitted sequentially.

In another embodiment of the system, an amount of data contained within the single A-scan is less than an amount of data contained within a plurality of A-scans acquired by full matrix capture (FMC).

In another embodiment of the system, an amount of data contained within the single A-scan is less than an amount of data contained within a plurality of A-scans acquired by plane wave imaging (PWI).

In another embodiment of the system, a rate of data generated during measurement of the single A-scan is less than a rate of data generated during measurement of a plurality of A-scans acquired by full matrix capture (FMC).

In another embodiment of the system, a rate of data generated during measurement of the single A-scan is less than a rate of data generated during measurement of a plurality of A-scans acquired by plane wave imaging (PWI).

In an embodiment, a non-transitory computer program product which, when executed by at least one data processor forming part of at least one computer, result in operations including transmitting, by a plurality of ultrasonic transducers arranged in a predetermined array, respective ultrasonic waves to form a plurality of plane waves. The plurality of plane waves can be oriented at different predetermined directions with respect to a reference axis and the plurality of plane waves are transmitted substantially simultaneously into the target. The operations can also include receiving, by the plurality ultrasonic transducers, ultrasonic echoes resulting from reflection of the plurality of plane waves from the target. The operations can further include measuring, by each ultrasonic transducer of the plurality of ultrasonic transducers, a single A-scan characterizing the ultrasonic echoes received at that ultrasonic transducer. The operations can additionally include generating, by a controller based upon the measured A-scans, an image representing the target. The plurality of operations can further include outputting, by the controller, data representing the generated image to a display device.

In another embodiment the plurality of plane waves are not transmitted sequentially.

In another embodiment an amount of data contained within the single A-scan is less than an amount of data contained within a plurality of A-scans acquired by full matrix capture (FMC).

In another embodiment an amount of data contained within the single A-scan is less than an amount of data contained within a plurality of A-scans acquired by plane wave imaging (PWI).

In another embodiment a rate of data generated during measurement of the single A-scan is less than a rate of data generated during measurement of a plurality of A-scans acquired by full matrix capture (FMC).

In another embodiment a rate of data generated during measurement of the single A-scan is less than a rate of data generated during measurement of a plurality of A-scans acquired by plane wave imaging (PWI).

### DESCRIPTION OF DRAWINGS

These and other features will be more readily understood from the following detailed description taken in conjunction with the accompanying drawings, in which:

FIG. 1A is a schematic diagram illustrating one exemplary embodiment of an operating environment including an ultrasonic inspection system and a target;

FIG. 1B is a schematic diagram illustrating the ultrasonic inspection system of FIG. 1A generating a plurality of ultrasonic beams simultaneously for evaluation of the target;

FIG. 2 is a schematic diagram illustrating a controller of the ultrasonic inspection system of FIGS. 1A-1B.

FIG. 3A is a schematic diagram illustrating an ultrasonic testing system employing full matrix capture (FMC) for data acquisition;

FIG. 3B is a schematic diagram illustrating an ultrasonic testing system employing plane wave imaging (PWI) for data acquisition;

FIG. 3C is a schematic diagram of an embodiment of the ultrasonic inspection system of FIGS. 1A-2 employing multi-plane wave imaging (multi-PWI) for data acquisition; and

FIG. 4 is a flow diagram illustrating one exemplary embodiment of a method for ultrasonic testing employing the ultrasonic inspection system of FIGS. 1A-1B.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Ultrasonic testing systems have been developed that can generate multi-dimensional images (e.g., two-dimensional, three-dimensional) of a target from ultrasonic test data. However, these systems can require acquisition of a large amount of ultrasonic data. In order to provide ultrasonic images for display in real-time, relatively complex electronics can be required to process the large amount of acquired ultrasonic data quickly. However, such complex electronics are costly. To address this issue, systems and methods for ultrasonic testing are provided that facilitate real-time display of ultrasonic images on less complex and costly electronics. As discussed in greater detail below, ultrasonic beams oriented in different directions can be generated simultaneously by an array of ultrasonic transducers and directed towards the target. The same ultrasonic transducers can each acquire a single measurement (e.g., an A-scan of amplitude as a function of time) for ultrasonic echoes reflected from the target. The amount of ultrasonic data collected in this manner is significantly reduced, as compared to existing ultrasonic testing systems. The reduced amount of ultrasonic data allows image processing to be performed on relatively low cost electronics (e.g., mobile processors) at a speed fast enough (e.g., milliseconds) to allow real-time display of generated ultrasonic images.

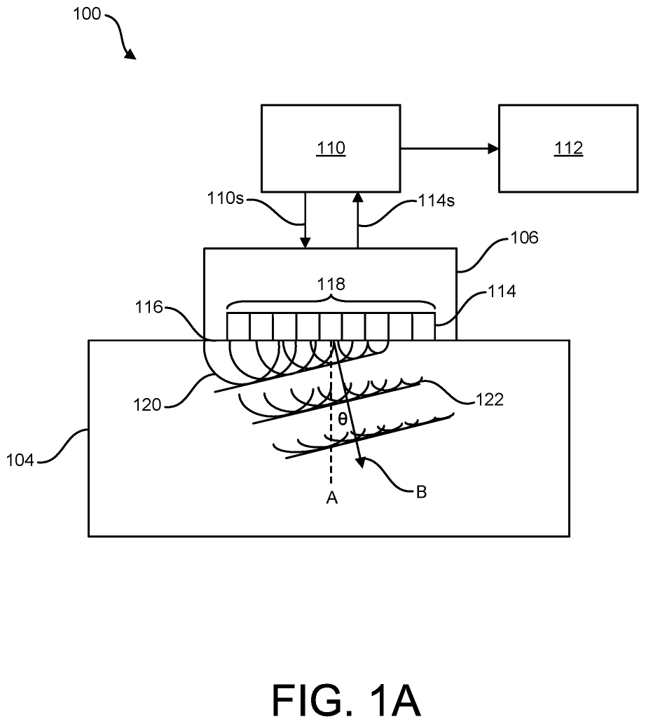

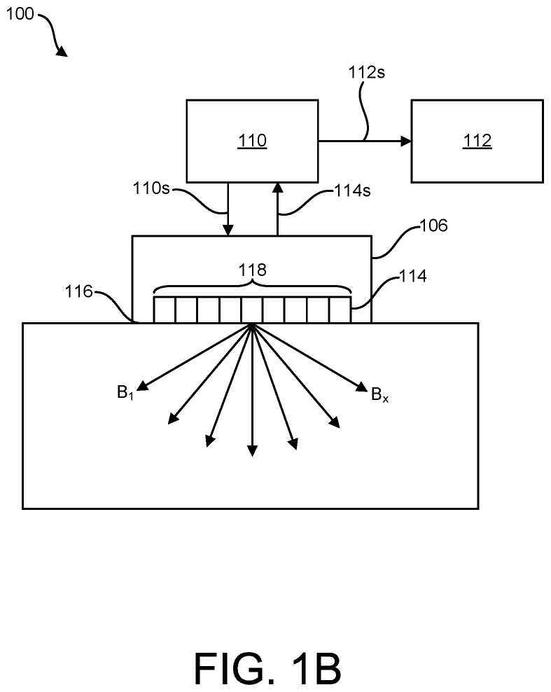

FIG. 1A illustrates one exemplary embodiment of an operating environment 100 including an ultrasonic inspection system 102 and a target 104. The ultrasonic inspection system 102 can be configured to measure ultrasonic data characterizing features of the target 104 such as defects (e.g., cracks, porosity, inhomogeneities, etc.) and to generate images representing such defects. The illustrated ultrasonic inspection system 102 includes an ultrasonic probe 106, a controller 110, and a display device 112. The ultrasonic probe 106 can include a plurality of ultrasonic transducers 114, adjacent to a sensing face 116 of the ultrasonic probe 106, and arranged in a predetermined layout, referred to as a matrix or array 118. The controller 110 can include one or more processors. Each of the ultrasonic transducers 114 can be configured to emit ultrasonic waves 120 in response to receipt of control signals 110s from the controller 110. The control signals 110s can be designed such that the ultrasonic waves 120 interfere with one another to form plane waves 122, orthogonal to a direction of travel of the plane waves 122. The collection of plane waves 122, traveling at an angle θ with respect to a reference axis A, can be referred to as an ultrasonic beam B. In this manner, the array 118 of ultrasonic transducers 114 can function as a phased array. Each of the ultrasonic transducers 114 can further configured to measure return measurement signals 114s to the controller 110 characterizing measured ultrasonic waves 120 reflected from the target 104.

In use, the sensing face 116 of the ultrasonic probe 106 can be placed adjacent to the target 104. For example, the sensing face 116 can be placed in direct contact with an outer surface of the target 104 or a fluid couplant (not shown) can be interposed between the target 104 and the sensing face 116.

So positioned, the controller 110 can provide respective control signals 110s (e.g., excitation pulses) to each of the ultrasonic transducers 114 to generate ultrasonic waves 120 providing substantially simultaneous transmission of a plurality of ultrasonic beams B at different angles θ (e.g., B₁-Bₓ) into the target, referred to as a shot, as shown in FIG. 1B.

In general, each angle of the ultrasonic beam B can require a delay law for control of ultrasonic waves 120 generated by each ultrasonic transducer 114. That is, the excitation pulse provided to each ultrasonic transducer 114 of the phased array 118 can be delayed by a predetermined amount in order to steer the ultrasonic beam B to adopt its angle θ. These delays can be calculated based on the pitch (spacing between individual ultrasonic transducers 114) of the phased array 118 and the velocity of sound in the target 104. Similarly, the excitation pulses of each ultrasonic transducer 114 can be calculated to steer the beam in the different directions with or without focusing. In this manner, the ultrasound beams B at different angles θ and, if necessary different focusing beams, in one shot. Plane waves, with a defined aperture (total width of all transducer elements firing at the same time) and at different angles can be fired in one shot by pre-calculating the excitation pulses of each ultrasonic transducer 114.

Subsequently, each of the ultrasonic transducers 114 can act as receivers, measuring data characterizing the amplitude and time of flight of reflected ultrasonic waves (A-scans) for all angles of the ultrasonic beams B. That is, each ultrasonic transducer 114 can measure a single A-scan for each shot and output one or more measurement signals 114s representing its measured A-scan. The controller 110 can be further configured to analyze the received measurement signals 114s to generate an image of the target 104. One or more image signals 112s can be output to the display device 112 for presentation to a user.

As discussed in greater detail below, ultrasonic imaging of the target 104 in this manner generates significantly fewer A-scans as compared to existing ultrasonic imaging techniques. Thus, the volume of data analyzed by the controller 110 to generate an image can be significantly less, facilitating rapid processing and real-time image display without the need for complex, costly electronics.

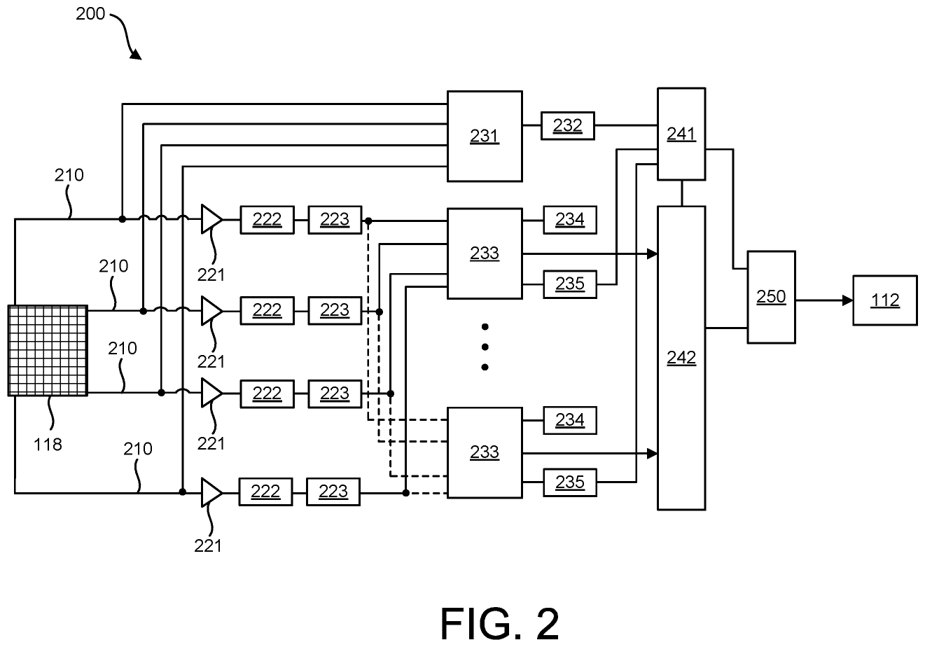

FIG. 2 is a schematic diagram illustrating one exemplary embodiment of the controller 110 in the form of controller 200. As illustrated, the controller 200 is in signal communication with the phased array 118 via control lines 210. While only four representative control lines 210 are shown in FIG. 2, each ultrasonic transducer 114 in the phased array 118 can be connected to the controller 200 by one of the control lines 210, with each of the control lines 210 operative to transmit electrical signals to the phased array 118 (e.g., control signals 110s), and for receiving electrical signals from the phased array 118 (e.g., measurement signals 114s).

The controller 200 can include a transmitter controller 231, a transmitter settings controller 232, and a cycle controller 241. The transmitter controller 231 can be configured to send electrical pulses to the ultrasonic transducers 114 in the phased array 118 over the control lines 210. Upon receipt of the electrical pulses, the ultrasonic transducers 114 can convert the electrical pulses into the ultrasonic waves 120. The transmitter settings controller 232 can be configured to provide the transmit delays for each of the ultrasonic transducers 114 to the transmitter controller 231 to coordinate a timing relationship for subsets of the ultrasonic transducers 114 to transmit an ultrasonic beams B at a predetermined angle θ. The cycle controller 241 can be connected to the transmitter settings controller 232 and it can be configured to coordinate and correlate the transmission of the ultrasonic waves 120 at different angles θ.

In addition to being connected to the transmitter controller 231, each ultrasonic transducer 114 of the phased array 118 can also be connected to an amplifier 221, a filter 222, and an analog to digital (A/D) converter 223 for receiving and digitizing reflected ultrasonic waves from the target 104. The reflected ultrasonic waves can be measured from the ultrasonic waves 120 transmitted by the same phased array 118.

The controller 200 can also include one or more receivers 233, receiver settings device 235, evaluation units 242, and storage devices 234. As an example, each of the receivers 233 can be connected to one or more of the A/D converters 223 and configured to receive digitized data representing the reflected ultrasonic waves regarding the target 104. The exact combination of data received by a given one of the receivers 233 can depend upon the processing requirements for any particular testing scheme employed by the ultrasonic inspection system 102. Outputs from each of the receivers 233 can be received for immediate processing at an evaluation units 242. In further embodiments, one of the storage devices 234 can be connected to each of the receivers 233 and configured to receive outputs from each of the receivers 233 for storage. The receivers 233 can also be configured to receive inputs from the receiver settings device 235 that include delay data determined in combination with the coordinated transmit delays in the transmitter settings controller 232, described above, under control of the cycle controller 241 for managing appropriate delay correlations between timed pulses for generating the ultrasonic waves 120 and received reflected ultrasonic echoes.

Embodiments of the controller 200 can also include one or more evaluation units 242 and one or more processors 250. The evaluation units 242 can receive outputs from the receivers 233 and can be further in communication with the cycle controller 241. The evaluation units 242 can be configured to analyze the ultrasonic digitized data and generate A-scan information as an output to processors 250. The processors 250 can be further configured to generate multi-dimensional images from the received A-scan information and transmit the generated multidimensional images as the image signals 112s for display by the display device 112. Examples of imaging generation techniques employed by the processors 250 can include time domain or frequency domain imaging techniques. In one aspect, time domain imaging techniques can include synthetic aperture focusing (SAFT) and total focusing method (TFM). In another aspect, frequency domain imaging techniques can include Fourier transformed SAFT (FTSAFT), also referred to as f-k migration.

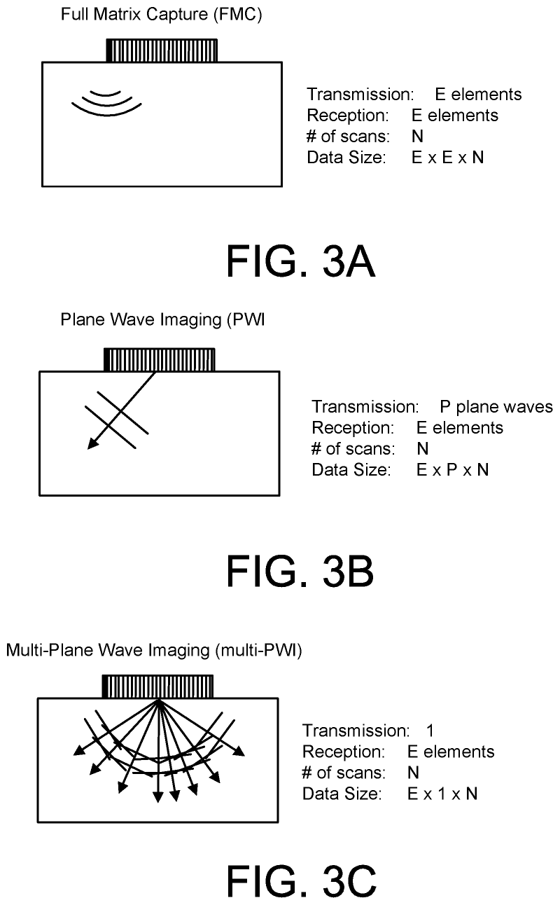

By employing multiple ultrasonic beams B fired simultaneously in a single shot, a significant reduction in measure A-scan data can be achieved. This data reduction can be understood with reference to FIGS. 3A-3C, illustrating ultrasonic data acquisition according to the full matrix capture (FMC) technique and the plane wave imaging (PWI) technique as compared to embodiments of the multi-plane wave imaging technique discussed herein.

The FMC technique is illustrated in FIG. 3A. As shown, single transducers of a phased array are fired consecutively, while each of the single transducers acts as a receiver of the reflected ultrasonic echoes. Assuming a phased array containing E transducer elements, each transducer measures E A-scans. This gives a total of E×E A-scans measured when each transducer element is fired a single time. Further assuming that each transducer is fired in a set N times, the total number of A-scans measured using the FMC technique is E×E×N.

The PWI technique is illustrated in FIG. 3B. As shown, transducers of a phased array fire plane waves using a defined aperture of the phased array and single transducers of the phase array probe act as receivers of the reflected ultrasonic echoes. Transmission and reception are performed sequentially. Assuming a phased array containing E transducer elements, and P plane waves at different angles, each transducer measures P A-scans. This gives a total of E×P A-scans measured when each plane wave is fired once. Further assuming that each plane wave is fired in a set N times, the total number of A-scans measured using the FMC technique is E×P×N.

An embodiment of multi-plane wave technique discussed herein is illustrated in FIG. 3C. As shown, the ultrasonic transducers 114 of the phased array 118 fire a single plane wave using a defined aperture of the phased array 118 and each ultrasonic transducer 114 of the phased array 118 acts as a receiver of the reflected ultrasonic echoes. Assuming a phased array containing E transducer elements, and all plane waves at different angles fired simultaneously P, each transducer measures a single A-scans. This gives a total of E×1 A-scans measured when each plane wave is fired once. Further assuming that each plane wave is fired in a set N times, the total number of A-scans measured using the FMC technique is E×1×N.

In general, regardless of the values assumed for E, P, and N, multi-PWI employs less A-scans than either FMC or PWI. For example, multi-PWI employs 1/E less A-scans compared to FMC and 1/P less A-scans compared to PWI. Assuming 64 transducer elements are present (E=64), 20 plane wave angles (P=20), multi-PWI employs 20 times fewer A-scans than PWI and 64 times fewer A-scans than FMC.

To better appreciate the data savings achieved by reducing the amount of A-scans, it is helpful to assume real-world values for the parameters discussed above, shown in Table 1 and discussed below.

TABLE 1
Comparison of data usage

| | Number of | Data Generated | Data Generation |
|---|---|---|---|
| | A-scans | Per Set (MB) | Rate (MB/sec) |
| FMC | 64 × 64 × 1024 | 8 | 240 |
| | (4,194,304) | | |
| PWI | 64 × 20 × 1024 | 2.5 | 75 |
| | (1,310,720) | | |
| Multi-PWI | 64 × 1 × 1024 | 0.125 | 3.75 |
| | 65,536 | | |

For example, assume a set of 1024 A-scans are performed (N=1024). FMC results in 4,194,304 A-scans per set, PWI results in 1,310,720 A-scans per set, and multi-PWI results in 65,536 A-scans per set. Further assuming that each A-scan uses 2 bytes (2B) of data storage, FMC uses 8 MB for each set of A-scans performed, PWI uses 2.5 MB for each set of A-scans performed, and multi-PWI uses 0.125 MB for each set of A-scans performed. Further assuming a sampling rate of 30 Hz, where each set of A-scans is performed 30 times per second, FMC generates data at a rate of 240 MB/sec, PWI generates data at a rate of 240 MB/sec, and multi-PWI generates data at a rate of 3.75 MB/sec.

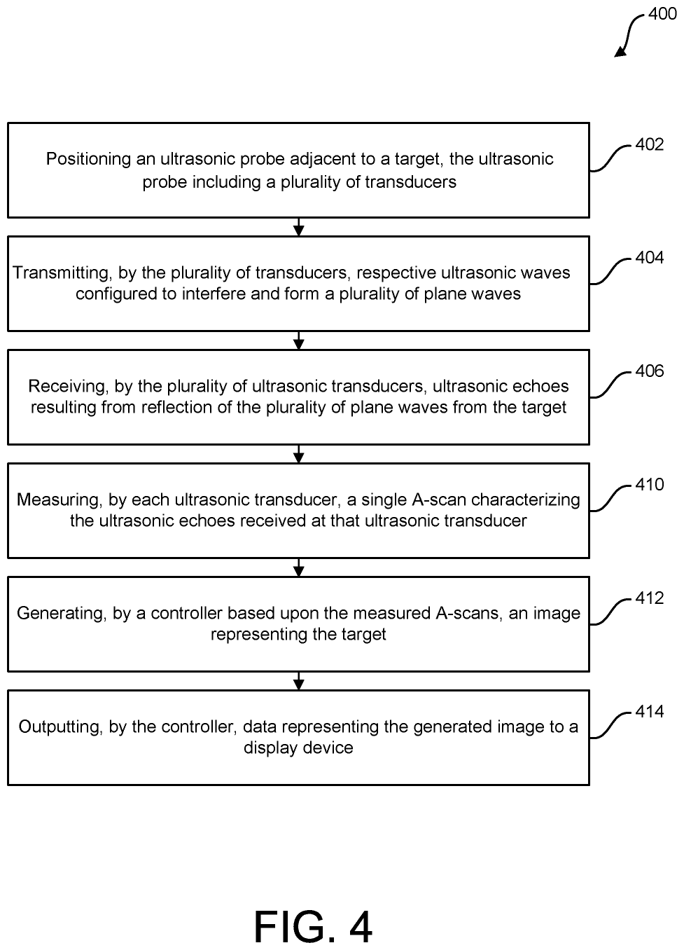

FIG. 4 is a flow diagram illustrating one exemplary embodiment of a method 400 for ultrasonic testing including operations 402-414. The method is discussed below with reference to the ultrasonic inspection system 102 of FIGS. 1A-2. Alternative embodiments of the method can include greater or fewer operations and the operations can be performed in an order different than that illustrated in FIG. 4.

In operation 402, the ultrasonic probe 106 is positioned adjacent to the target 104. As an example, the sensing face 116 of the ultrasonic probe 106 can be positioned directly in contact with the target 104 or a layer of a couplant (e.g., a fluid couplant) can be interposed between the sensing face 116 and the target 104. The ultrasonic probe 106 can include the plurality of ultrasonic transducers 114.

In operation 404, the plurality of ultrasonic transducers 114 can transmit respective ultrasonic waves 120 into the target 104. The transmitted ultrasonic waves 120 can be configured to interfere with one another to form the plurality of plane waves 122. Each of the plane waves 122 can be oriented at different predetermined directions (e.g., different angles θ) with respect to the reference axis A. As an example, the controller 110 can provide control signals 110s operative to cause the plurality of transducers to transmit the plurality of ultrasonic waves 120.

In operation 406, the plurality of ultrasonic transducers 114 can receive ultrasonic echoes resulting from reflection of the plurality of plane waves 122 from the target 104. In operation 410, each ultrasonic transducer of the plurality of ultrasonic transducers can measure a single A-scan (e.g., amplitude as a function of time or time of flight). The single A-scan received at a given ultrasonic transducer 114 can characterize the ultrasonic echoes received at that ultrasonic transducer.

In operation 412, the controller 110 can receive one or more measurement signals 114s from each ultrasonic transducer 114 representing the A-scan measured by that ultrasonic transducer 114. Based upon these measured A-scans, the controller 110 can generate an image representing the target 104. As an example, the image can be a multi-dimensional image (e.g., two-dimensional, three-dimensional, etc.) including representation of one or more defects and/or geometric features of the target 104.

In operation 414, data representing the generated image (e.g., image signals 112s) to the display device 112. In certain embodiments, the generated image can be output and displayed substantially concurrently with transmission of the plurality of ultrasonic waves 120 into the target 104. In this manner, images of the target 104 can be displayed in real-time with performance of ultrasonic testing.

Exemplary technical effects of the methods, systems, and devices described herein include, by way of non-limiting example reduction of data acquired when performing ultrasonic testing of target materials. This data reduction enables processing of acquired ultrasonic data in real-time without use of complex and costly electronic components. Significant cost savings can be achieved as a result.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method, comprising:
positioning an ultrasonic probe adjacent to a target, the ultrasonic probe including a plurality of ultrasonic transducers arranged in a predetermined array;
transmitting, by the plurality of ultrasonic transducers, respective ultrasonic waves to form a plurality of plane waves, wherein the plurality of plane waves are oriented at different predetermined directions with respect to a reference axis and the plurality of plane waves are transmitted substantially simultaneously into the target;
receiving, by the plurality ultrasonic transducers, ultrasonic echoes resulting from reflection of the plurality of plane waves from the target;
measuring, by each ultrasonic transducer of the plurality of ultrasonic transducers, a single A-scan characterizing the ultrasonic echoes received at that ultrasonic transducer;
generating, by a controller based upon the measured A-scans, an image representing the target; and
outputting, by the controller, data representing the generated image to a display device.

2. The method of claim 1, wherein the plurality of ultrasonic transducers are a phased array.

3. The method of claim 1, wherein the plurality of plane waves are not transmitted sequentially.

4. The method of claim 1, wherein an amount of data contained within the single A-scan is less than an amount of data contained within a plurality of A-scans acquired by full matrix capture (FMC).

5. The method of claim 1, wherein an amount of data contained within the single A-scan is less than an amount of data contained within a plurality of A-scans acquired by plane wave imaging (PWI).

6. The method of claim 1, wherein a rate of data generated during measurement of the single A-scan is less than a rate of data generated during measurement of a plurality of A-scans acquired by full matrix capture (FMC).

7. The method of claim 1, wherein a rate of data generated during measurement of the single A-scan is less than a rate of data generated during measurement of a plurality of A-scans acquired by plane wave imaging (PWI).

8. An ultrasonic testing system, comprising:
an ultrasonic probe including a plurality of ultrasonic transducers arranged in a predetermined array, the plurality of ultrasonic transducers being configured to:
transmit respective ultrasonic waves in response to receipt of control signals to form a plurality of plane waves, wherein the plurality of plane waves are oriented at different predetermined directions with respect to a reference axis and the plurality of plane waves are transmitted substantially simultaneously into the target;
receive ultrasonic echoes resulting from reflection of the plurality of plane waves from the target; and
measure a single A-scan characterizing the ultrasonic echoes received at respective ones of the plurality of ultrasonic transducers; and
a controller including one or more processors and configured to:
transmit the control signals to the plurality of ultrasonic transducers;
generate, based upon the measured A-scans, an image representing the target; and
output data representing the generated image to a display device.

9. The system of claim 8, wherein the plurality of ultrasonic transducers are a phased array.

10. The system of claim 8, wherein the plurality of plane waves are not transmitted sequentially.

11. The system of claim 8, wherein an amount of data contained within the single A-scan is less than an amount of data contained within a plurality of A-scans acquired by full matrix capture (FMC).

12. The system of claim 8, wherein an amount of data contained within the single A-scan is less than an amount of data contained within a plurality of A-scans acquired by plane wave imaging (PWI).

13. The system of claim 8, wherein a rate of data generated during measurement of the single A-scan is less than a rate of data generated during measurement of a plurality of A-scans acquired by full matrix capture (FMC).

14. The system of claim 8, wherein a rate of data generated during measurement of the single A-scan is less than a rate of data generated during measurement of a plurality of A-scans acquired by plane wave imaging (PWI).

15. A non-transitory computer program product which, when executed by at least one data processor forming part of at least one computer, result in operations comprising:
transmitting, by a plurality of ultrasonic transducers arranged in a predetermined array, respective ultrasonic waves to form a plurality of plane waves, wherein the plurality of plane waves are oriented at different predetermined directions with respect to a reference axis and the plurality of plane waves are transmitted substantially simultaneously into the target;
receiving, by the plurality ultrasonic transducers, ultrasonic echoes resulting from reflection of the plurality of plane waves from the target;
measuring, by each ultrasonic transducer of the plurality of ultrasonic transducers, a single A-scan characterizing the ultrasonic echoes received at that ultrasonic transducer;
generating, by a controller based upon the measured A-scans, an image representing the target; and
outputting, by the controller, data representing the generated image to a display device.

16. The computer program product of claim 15, wherein the plurality of plane waves are not transmitted sequentially.

17. The computer program product of claim 15, wherein an amount of data contained within the single A-scan is less than an amount of data contained within a plurality of A-scans acquired by full matrix capture (FMC).

18. The computer program product of claim 15, wherein an amount of data contained within the single A-scan is less than an amount of data contained within a plurality of A-scans acquired by plane wave imaging (PWI).

19. The computer program product of claim 15, wherein a rate of data generated during measurement of the single A-scan is less than a rate of data generated during measurement of a plurality of A-scans acquired by full matrix capture (FMC).

20. The computer program product of claim 15, wherein a rate of data generated during measurement of the single A-scan is less than a rate of data generated during measurement of a plurality of A-scans acquired by plane wave imaging (PWI).
